(19) United States
(12) Patent Application Publication
(10) Pub. No.: US 2012/0247104 A1
(43) Pub. Date: Oct. 4, 2012

(54) SYSTEM AND METHOD FOR CONTROLLING WASTE HEAT FOR CO2 CAPTURE

(75) Inventors: Nareshkumar B. HANDAGAMA, Knoxville, TN (US); Rasesh R. KOTDAWALA, Knoxville, TN (US); Staffan Jönsson, Wohlen (CH); Allen M. PFEFFER, Windsor Locks, CT (US); Olivier DRENIK, Belfort (FR); Jacques MARCHAND, Sermamagny (FR); Craig Norman SCHUBERT, Lake Jackson, TX (US)

(73) Assignees: DOW GLOBAL TECHNOLOGIES LLC., Midland, MI (US); ALSTOM TECHNOLOGY LTD., Baden (CH)

(21) Appl. No.: 13/432,350

(22) Filed: Mar. 28, 2012

Related U.S. Application Data
(60) Provisional application No. 61/469,919, filed on Mar. 31, 2011.
(60) Provisional application No. 61/469,915, filed on Mar. 31, 2011.

(51) Int. Cl. F01K 19/00; B01D 53/14

(52) U.S. Cl. 60/670; 95/156; 95/1

(57) ABSTRACT

The present invention relates to systems and methods for providing steam to a gas recovery unit 130 based on changes to steam flow to and/or power generated by a power generation unit 119. The gas recovery unit 130 may part of a thermal power generation unit 100 and may be an amine based CO2 recovery unit including two or more regenerator columns 153.

The present application claims the benefit under 35 U.S.C. §119(e) of Provisional Patent Application Ser. No. 61/469,919 entitled A SYSTEM AND METHOD FOR CONTROLLING WASTE HEAT FOR CO2 CAPTURE filed Mar. 31, 2011, the disclosure of which is incorporated herein by reference in its entirety.

### CROSS-REFERENCE TO RELATED APPLICATIONS

This Application is related to U.S. Patent Application No. 61/469,915, Attorney Docket No. W09/078-0(27849-0011), filed contemporaneously with this Application on Mar. 31, 2011, entitled “A SYSTEM AND METHOD FOR CONTROLLING WASTE HEAT FOR CO₂ CAPTURE” assigned to the assignee of the present invention and which is incorporated herein by reference in its entirety.

### FIELD OF THE INVENTION

The present invention generally relates to a thermal power plant. The present invention more particularly relates to methods and systems to integrate process control schemes for the capture of carbon dioxide with power plant steam to minimize waste heat.

### BACKGROUND

Fossil fuel and natural gas power stations conventially use steam turbines and other machines to convert heat into electricity. The combustion of these fuels produce a flue gas stream that includes acid gases including carbon dioxide CO₂, nitrogen oxides NOₓ and sulfur oxides SOₓ. Efforts have been made to reduce the emission of acid gases from these power stations, and in particular, to reduce the emission of greenhouse gases including CO₂. As such, CO₂ capture systems have been integrated into these power stations. Numerous advances have been made in this respect, leading to the CO₂ generated during the combustion of fossil fuels being partly to completely separated from the combustion gases. Recently, there has been interest in aqueous absorption and stripping processes using aqueous amines to remove acid gas contaminants from combustion gas streams.

Gas absorption is a process in which soluble components of a gas mixture are dissolved in a liquid. Gas/liquid contact can be counter-current or co-current, with counter-current contact being most commonly practiced. Stripping is essentially the inverse of absorption, as it involves the transfer of volatile components from a liquid mixture to a gas. In a typical carbon dioxide removal process, absorption is used to remove carbon dioxide from a combustion gas, and stripping is subsequently used to regenerate the solvent and capture the carbon dioxide contained in the solvent. Once carbon dioxide is removed from combustion gases and other gases, it can be captured and compressed for use in a number of applications, including sequestraton, production of methanol, and tertiary oil recovery.

To effect the regeneration of the absorbent solution, the rich solvent drawn off from the bottom of the absorption column is introduced into the upper half of a stripping column, and the rich solvent is maintained at an elevated temperature at or near its boiling point under pressure. The heat necessary for maintaining the elevated temperature is furnished by reboiling the absorbent solution contained in the stripping column, which requires energy and thus increases overall operational costs.

Hence, there exists a need to provide a cost effective and operationally efficient energy source to the reboilers to regenerate the loaded aqueous amine stream.

### SUMMARY OF THE INVENTION

An objective of the present invention is to provide a system and method for efficiently providing heat to an acid gas absorption/stripping process integrated with a steam power generation system.

Another objective of the present invention is to optimize overall power generation plant performance by the use of special arrangements of steam tapings (extraction points) from different turbine stages and water and/or steam cycle locations to provide energy for acid gas capture systems.

Another objective of the present invention is to provide special arrangements of steam tapings (extraction points) from different turbine stages and water and/or steam cycle locations to provide energy for acid gas capture systems that can be designed into new or retrofitted into existing power generation system designs.

Another objective of the present disclosure is to provide process control schemes to integrate steam power generation load and energy production for acid gas capture.

Accordingly, and depending on the operational and design parameters of a known technology for capture of acidic gases, an objective of the present invention may reside in the reduction of energy.

Furthermore, an objective of the present invention may reside in the environmental, health and/or economical improvements of reduced emission of chemicals used in such a technology for acid gas absorption.

In one aspect, a plant is disclosed that includes a boiler unit that produces steam, a power generation unit including at least one power generation turbine that receives the steam from the boiler unit, a gas recovery unit including two or more regenerator columns, and a secondary source of steam providing steam to each of the two or more regenerators columns at different rates.

In another aspect, a method for providing steam to a gas recovery unit is disclosed that includes providing steam to a secondary source of steam from either a boiler unit or a power generation unit, and discharging steam from the secondary source of steam, providing steam discharged from the secondary source of steam to two or regenerator columns of a gas recovery unit at different rates.

### BRIEF DESCRIPTION OF THE DRAWINGS

Referring now to the figures, which are exemplary embodiments, and wherein the like elements are numbered alike.

FIG. 1 illustrates a schematic, simplified process diagram of a plant according to an embodiment of the disclosure.

FIG. 2 illustrates a schematic, simplified process diagram of a plant according to another embodiment of the disclosure.

FIG. 3 illustrates a schematic, simplified process diagram of a plant according to another embodiment of the disclosure.

FIG. 4 illustrates a schematic, simplified process diagram of a plant according to another embodiment of the disclosure.

FIG. 5 illustrates a schematic, simplified process diagram of a plant according to another embodiment of the disclosure.

FIG. 6 illustrates a schematic, simplified process diagram of a plant according to another embodiment of the disclosure.

FIG. 7 illustrates a schematic, simplified process diagram of a plant according to another embodiment of the disclosure.

FIG. 8 illustrates a schematic, simplified process diagram of a plant according to another embodiment of the disclosure.

FIG. 9 illustrates a schematic, simplified process diagram of a plant according to another embodiment of the disclosure.

### DETAILED DESCRIPTION

Specific embodiments of systems and processes for utilizing power generation steam to provide energy to acid gas recovery according to the invention are described below with reference to the drawings.

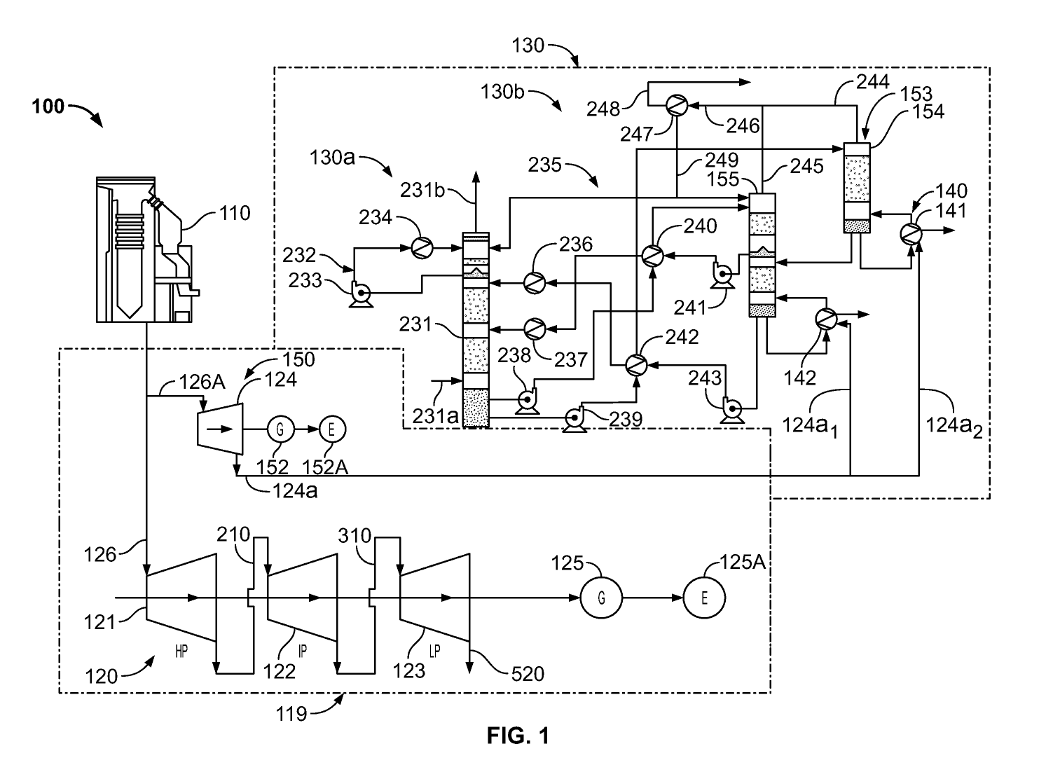

FIG. 1 illustrates a schematic, simplified process diagram of a plant 100 according to an embodiment of the disclosure. In one embodiment, the thermal system 100 may be a thermal power plant. In another embodiment, the plant 100 may be a plant or facility including a combustion facility generating a carbon dioxide containing flue gas and at least one steam unit. The steam unit may be a steam turbine power generation unit.

As can be seen in FIG. 1, the plant 100 includes a primary source of steam 110, a power generation unit 119 and a gas recovery unit 130. In this exemplary embodiment, the primary source of steam 110 is a steam boiler unit. The steam boiler unit 110 may include one or more steam boilers that produce steam from a fossil fuel. The fuel may be coal, peat, biomass, synthetic gas/fuels, natural gas or other carbon fuel source, that when combusted produces a flue gas containing gas contaminants such as acid gases.

The power generation unit 119 includes a primary consumer of steam 120 and a power generation unit 125. In this exemplary embodiment, the primary consumer of steam 120 is one or more steam turbines. The one or more steam turbines 120 are coupled to the power generation unit 125 to provide mechanical energy to the power generator 125 to generate electricity 125A. The electricity may be provided to an electrical power grid (not shown). In this exemplary embodiment, the one or more steam turbines 120 includes a high pressure (HP) turbine 121, an intermediate pressure (IP) turbine 122, and a low pressure (LP) turbine 123. In another embodiment, the one or more steam turbines 120 may include a combination of any number of turbines of similar or varying operation pressure(s).

As can be further seen in FIG. 1, the power generation unit 119 further includes a secondary consumer of steam 124. In this exemplary embodiment, the secondary consumer of steam 124 is an auxiliary steam turbine. The auxiliary steam turbine 124 may be a back pressure turbine. The auxiliary steam turbine 124 is coupled to an auxiliary generator 152. The auxiliary generator 152 generates electricity 152A that may be provided to an electrical power grid, a plant local electrical power grid, or other local energy supply (not shown). The amount of energy provided to the electrical grid may be increased or decreased depending on the electrical grid load requirement. The electrical grid load requirement may provide a setpoint to a speed control (not shown) of the auxiliary steam turbine 124. In one embodiment, the setpoint may have an override based on the pressure of the exhaust steam of the auxiliary turbine 124.

The gas recovery unit 130 may be an acid gas capture and recovery unit. The gas recover unit 130 includes a CO₂ absorption unit 130a and a CO₂ regeneration unit 130b. In one embodiment, the gas recovery unit 130 may be an amine based scrubbing unit. In one embodiment, the gas recovery unit 130 may be an advanced amine process for CO₂ capture. In one embodiment, the advanced amine process may be a double matrix scheme including a matrix stripping configuration.

The CO₂ absorption unit 130a includes a CO₂ absorber (absorber) 231. The CO₂ regeneration unit 130b includes two or more regenerator columns 153. Each regenerator column of the two or more regenerator columns 153 includes two or more reboilers 140. In one embodiment, one or more of the regenerator columns may have two or more reboilers. The arrangement of two or more regenerator columns 153 may be referred to as a matrix stripping configuration. In this exemplary embodiment, the two or more regenerator columns 153 includes a high pressure (HP) regenerator column 154 and associated first reboiler 141 and a low pressure (LP) regenerator column 155 and associated second reboiler 142.

The absorber 231 is provided a gas stream containing CO₂ from the steam boiler unit 110 via a feed line 231a. The gas steam may be a flue gas steam. In one embodiment, the flue gas may be treated by a flue gas desulfurization unit (not shown) and/or a cooling unit (not shown) before being provided to the absorber 231. In the absorber 231, flue gas is contacted with a solvent solution that removes CO₂ from the flue gas by absorption. The solvent solution may be an amine-based solvent solution. The flue gas stream, having CO₂ removed, is discharged from the absorber 231 via a discharge line 231b. The absorber 231 may further include a fluid wash cycle 232 that may include a fluid wash pump 233 and a fluid wash cooler 234 to eliminate any solvent carryover.

To effect the regeneration of the solvent solution, the rich CO₂ solvent solution drawn off from the bottom of the absorber 231 is introduced into the upper half of each of the two or more regenerator columns 153, and the rich solvent is maintained at a temperature at which CO₂ boils off under pressure in each column. The heat necessary for maintaining the boiling point is furnished by one or more reboilers associated with each regenerator column. The reboiling process is effectuated by indirect heat exchange between part of the solution to be regenerated and a hot fluid at appropriate temperature. In the course of regeneration, the carbon dioxide contained in the rich solvent to be regenerated maintained at its boiler point is released and stripped by the vapors of the absorbent solution. Vapor containing the stripped CO₂ emerges at the top of the regenerator column and is passed through a condenser system which returns to the regenerator column the liquid phase resulting from the condensation of the vapors of the absorbent solution that pass out of the regenerator column with the gaseous CO₂. At the bottom of the regenerator column, the hot regenerated absorbent solution, also called the lean solvent solution, is drawn off and recycled.

In this exemplary embodiment, the HP regenerator column 154 and the LP regenerator column 155 are interconnected with the CO₂ absorber 231 by a fluid interconnection system 235 that circulates solvent solution for CO₂ absorption/desorption. The fluid interconnection system includes a lean cooler 236, a semi-lean cooler 237, a LP rich solution pump 238, a HP rich solution pump 239, a semi-lean/rich heat exchanger 240, a semi-lean solution pump 241, a lean/rich heat exchanger 242, a lean solution pump 243 and various lines and feeds as shown.

The solvent solution, such as an amine solution, from the CO₂ absorber 231, which is discharged from the CO₂ absorber rich in CO₂, or in other words, CO₂ rich solvent, is provided to the HP regenerator column 154 and the LP regenerator column 155 where CO₂ is stripped from the solvent. CO₂ is discharged from the HP regenerator column 154 and the LP regenerator column 155 via discharge lines 244 and 245, respectively, which combine for form a discharge line 246. Discharge line 246 feeds a CO₂ cooler, where residual moisture is removed from the CO₂ stream. A CO₂ product stream is discharged from the gas recovery unit 130 via CO₂ product discharge line 248.

As can be further seen in FIG. 1, the steam boiler unit 110 provides high pressure steam to the high pressure turbine 121 via a high pressure steam line 126. High pressure steam may be at a pressure between about 270 bar and 300 bar and temperature between about 600° C. and 700° C. The flow of high pressure steam provided to the high pressure turbine 121 is proportional to the overall plant load. The overall plant load is the total amount of power generated by the plant 100. High pressure steam is tapped from the high pressure steam line 126 via auxiliary high pressure (HP) steam line 126A and fed to the auxiliary turbine 124, which is coupled to a auxiliary power generator 152 to produce electricity.

Reduced pressure steam is discharged from the auxiliary turbine 124 and provided to the gas recovery unit 130 via an auxiliary steam line 124a. The reduced pressure steam may be provided at a pressure of between about 5 bar and about 20 bar and at a temperature of less than about 300° C.

The reduced pressure steam provided to the gas recovery unit 130 is provided to the first reboiler 141 and the second reboiler 142 via first and second auxiliary steam lines 124a₂, 124a₁, respectively. The reduced pressure steam is provided to each of the two or more regenerator columns 153 simultaneously and at different rates. Providing steam at different rates may include providing steam at different pressure, temperature and/or flow volume. Providing steam to each of the two or more regenerator columns 153 at different rates may be used to provided a different amount of energy to the each of the two or more regenerator columns 153 to improve the controllability of each regenerator column. The steam is provided to the two or more regenerator columns 153 at different rates by controlling the quality of the steam by using one or more steam control devices, such as but not limited to valves, expansion devices, throttling devices and any combination thereof. The regenerators 153 function in synch, however, the CO₂ stripping rates and column pressures are different, to optimize the gas capture and recovery system 130 with respect to CO₂ capture and energy. The first auxiliary steam line 124a₂ and a second auxiliary steam line 124a₁ provide steam to the first and second reboilers 141, 142 at different rates that provided a different amount of energy to the first and second reboilers 141, 142 to improve the controllability of each reboiler, which subsequently improves the controllability of the HP regenerator column 154 and the LP regenerator column 155, respectively. By improving the control of the HP regenerator column 154 and the LP regenerator column 155 by controlling the rate of steam to the first and second reboilers 141, 142, respectively, the power production of the power generation unit 119 is minimally reduced, or in other words, incurs the minimum penalty of the power production of the plant 100. Therefore the heat duty delivery is provided independent and flexible to maintain optimality of the system. In another embodiment, the reduced pressure steam is provided to the two or more reboilers 140 via two or more auxiliary steam lines.

According to the provided system and method, steam flow to the auxiliary turbine 124 is proportional to the power generated by the plant 100. In other words, more power generated by the plant 100 results in more steam available to be provided to the auxiliary turbine 124 and more steam available to the acid gas recovery unit 130. This provides a coarse anticipatory control action as the plant load changes.

In another embodiment, the ratio of steam to the auxiliary turbine 124 and steam provided to the HP turbine 121 may be calculated and maintained to a fixed value. The calculated ratio may provide a setpoint to the speed control of the HP turbine to minimize the pressure losses due to throttling the flow to the auxiliary turbine. In another embodiment, a top stage column temperature of the low pressure (LP) regenerator column 155 may be used to set the reboiler duty in the second reboiler 142.

The steam flow from the auxiliary turbine 124 to the two or more reboilers 140 may be used to control the regeneration of CO₂ in the HP and LP regenerator columns 154, 155 since the flow of steam from the auxiliary turbine 124 to first and second reboilers 141, 142 may be used to control the temperature of the HP and LP regenerator columns 154, 155.

As shown in FIG. 1, the location where steam is tapped is generally shown on a steam line. However, FIG. 1 and the later figures in this disclosure are intended to include tapping into steam at a line or component position that provides a source of steam of a desired steam quality. For example, steam may be tapped from a heat exchanger, condenser, bypass, turbine structure or other steam passing component that provides steam of the desired quality.

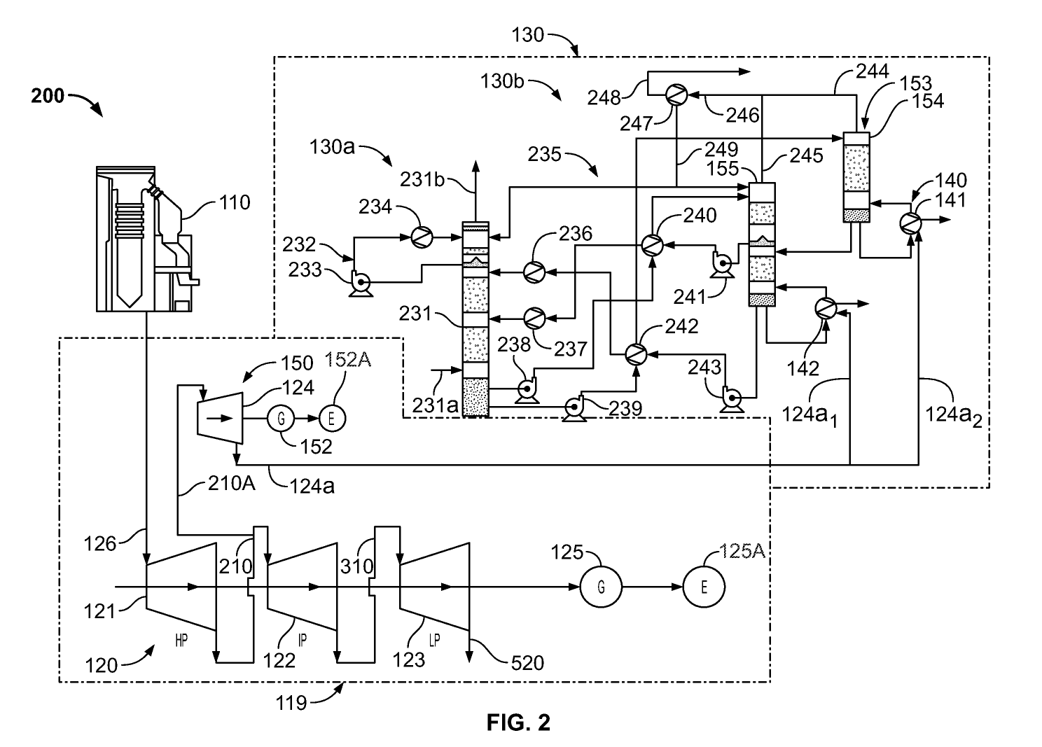

FIG. 2 illustrates a schematic, simplified process diagram of a plant 200 according to another embodiment of the disclosure. The primary components of the plant 200 are the same as shown and described above with reference to the plant 100 of FIG. 1. However, in this embodiment, steam from to the auxiliary turbine 124 is tapped from the IP steam line 210 between the HP turbine 121 and the IP turbine 122 and provided to the auxiliary turbine 124 via auxiliary IP steam line 210A. In one embodiment, the steam in the IP steam line 210 is between about 50 bar and about 60 bar. In another embodiment, the steam in the IP steam line 210 is between about 58 bar and about 60 bar. In another embodiment, the steam in the IP steam line 210 is between about 450° C. and 620° C. In another embodiment, the steam in the IP steam line is between about 480° C. and 520° C. In yet another embodiment, the pressure in the IP steam line is about 500° C.

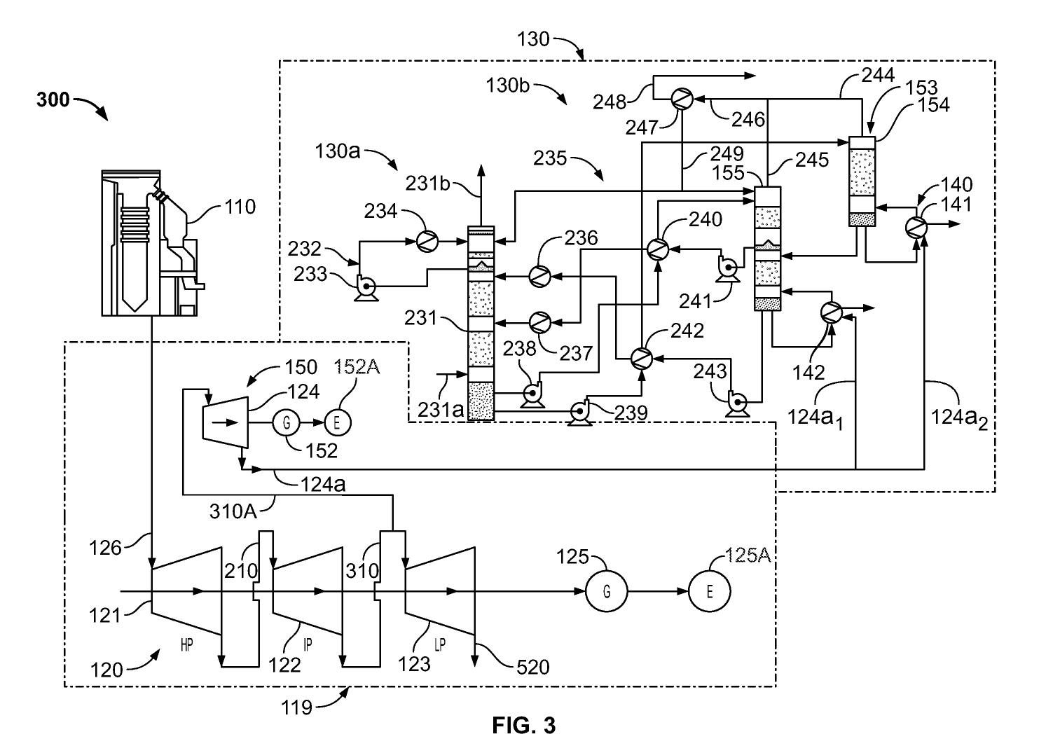

FIG. 3 illustrates a schematic, simplified process diagram of a plant 300 according to another embodiment of the disclosure. The primary components of the plant 300 are the same as shown and described above with reference to the plant 100 of FIG. 1. However, in this embodiment, steam from to the auxiliary turbine 124 is tapped from the LP steam line 310 between the IP turbine 122 and the LP turbine 123.

In one embodiment, the steam in the LP steam line 310 is between about 3 bar and about 7 bar. In another embodiment, the steam in the LP steam line 310 is between about 4 bar and about 6 bar. In another embodiment, the steam in the LP line 310 is about 5 bar. In another embodiment, the steam in the LP feed line 310 is between about 300° C. and 400° C. In another embodiment, the steam in the LP steam line is between about 340° C. and 400° C. In yet another embodiment, the pressure in the LP steam line is about 400° C.

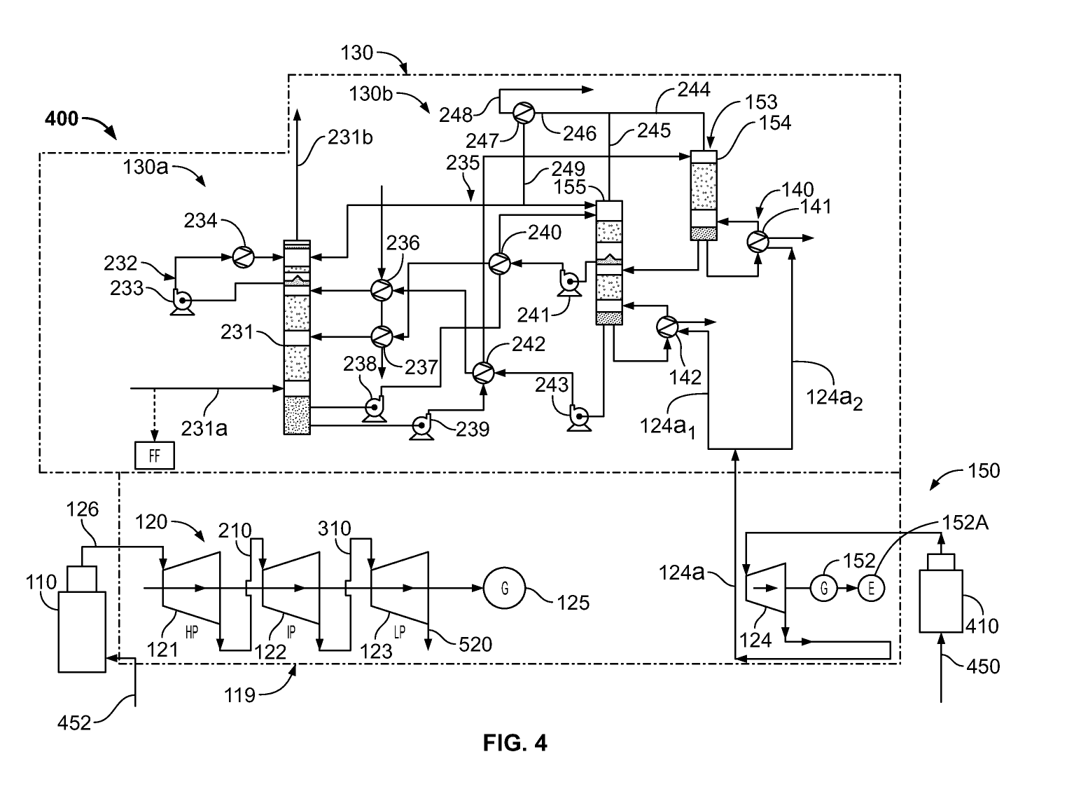

FIG. 4 illustrates a schematic, simplified process diagram of a plant 400 according to another embodiment of the disclosure. The primary components of the plant 400 are the same as shown and described above with reference to the plant 100 of FIG. 1. However, in this embodiment, the auxiliary turbine 124 is provided steam from an auxiliary boiler 410. Since an auxiliary boiler 410 is provided, the flue gas flow and the heat input from the steam boiler unit 110 to the acid gas recovery unit 130 are decoupled. In one embodiment, when the load on the main boiler changes, the load on the auxiliary boiler 410 is changed. The load on the auxiliary boiler 410 may be changed to maintain the ratio of steam generated by the auxiliary boiler 410 and the steam boiler unit 110. In another embodiment, the load on the auxiliary boiler 410 is changed by changing the fuel feed to the auxiliary boiler 410 based on a change in the fuel feed to the steam boiler unit 110.

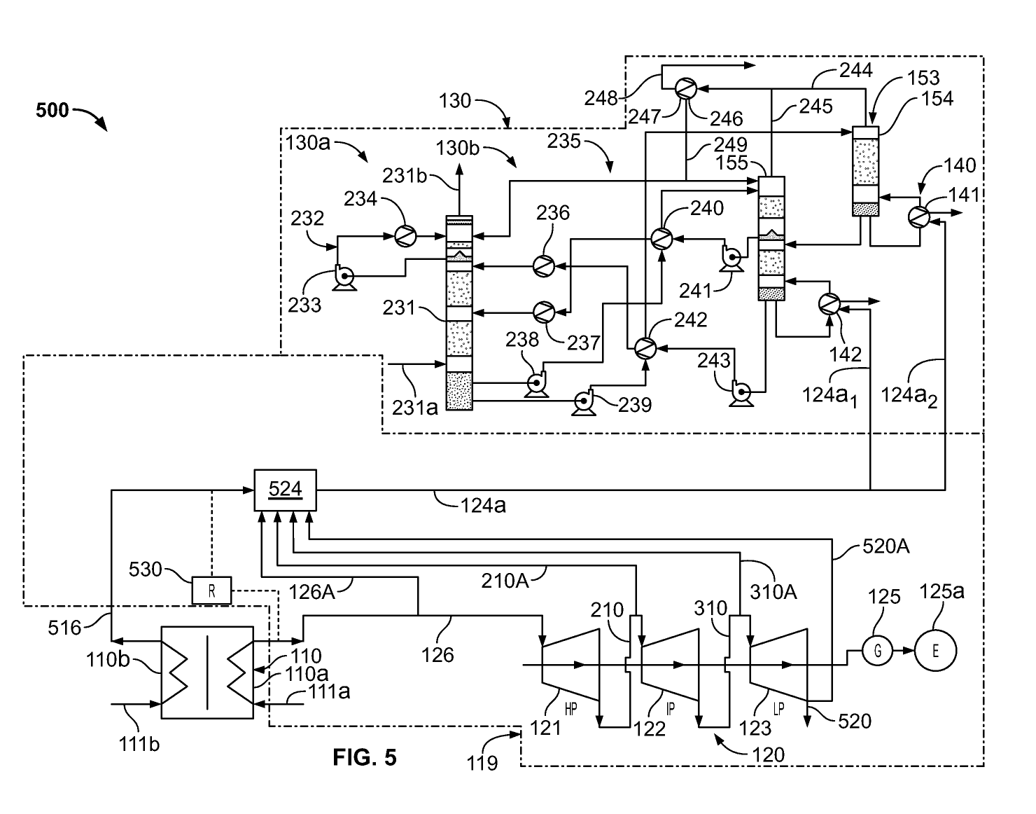

FIG. 5 illustrates a schematic, simplified process diagram of a plant 500 according to another embodiment of the disclosure. The primary components of the plant 500 are the same as shown and described above with reference to the plant 100 of FIG. 1. In this embodiment, a secondary consumer of steam 524 is a steam mixer. The steam mixer 524 may be a steam saturator. In another embodiment, the secondary consumer of steam 524 may be a steam device that receives one or more steam feeds of the same or various steam quality and produces a resultant steam discharge of a desired steam quality. The steam saturator 524 receives steam feeds of the same or similar steam quality and combines the various steam feeds to generate a steam discharge of a desired steam quality. In one embodiment, the steam discharge is a saturated steam discharge. The steam feeds may be any combination of steam, saturated or supersaturated steam, and water. The steam saturator 524 is provided with steam from the steam boiler unit 110 and from various steam taps in the power generation unit 119.

The boiler unit 110 includes a primary boiler loop 110a and a secondary boiler loop 110b. The primary boiler loop 110a receives water via a primary feed line 111a and discharges steam via a high pressure steam line 126. The secondary boiler loop 110b receives water via a secondary feed line 111b and discharges steam via a secondary steam line 516. In one embodiment, the steam discharged via the secondary steam line 516 is high pressure steam.

The steam saturator 524 receives steam from the secondary steam line 516. In one embodiment, steam from the secondary steam line 516 is provided to the steam saturator 524 at a pressure of between about 250 bar to about 320 bar and at a temperature of between about 580° C. and about 700° C. In another embodiment, the secondary steam line 516 provides steam to the steam saturator 524 at a pressure of between about 280 bar to about 300 bar and at a temperature of between about 600° C. and about 670° C.

As can be seen in FIG. 5, the steam saturator 524 is further provided with steam from the power generation unit 119 including: HP steam from the HP steam line 126 via an auxiliary HP steam line 126A; IP steam from the IP steam feed line 210 between the HP turbine 121 and the IP turbine 122 via an auxiliary IP steam line 210A; LP steam from the LP steam line 310 between the IP turbine 122 and the LP turbine 123 via an auxiliary LP steam line 310A; and discharge steam form a discharge steam line 520 discharging steam from the LP turbine 123 via an auxiliary discharge steam line 520A.

In one embodiment, the steam from the secondary steam line 516 is between about 500° C. and about 600° C. In another embodiment, the steam from the secondary steam line 516 is between about 510° C. and about 565° C. In another embodiment, the steam from the secondary steam line 516 is between about 150 bar and about 175 bar. In another embodiment, the steam from the secondary steam line 516 is between about 160 bar and about 165 bar.

Steam is provided and combined to the steam saturator 524 in a manner that produces a desired steam flow to the acid gas recovery unit 130 via auxiliary steam line 124a. In one embodiment, the reduced pressure steam may be provided at a pressure of between about 5 bar and about 20 bar and at a temperature of less than about 300° C. The reduced pressure steam is provided to first reboiler 141 and second reboiler 142. In another embodiment, the reduced pressure steam is provided to one or more reboilers. Depending on the power generation unit 119 demands, one or more of the auxiliary steam lines, as well as the secondary steam line 516 may be utilized or shut off.

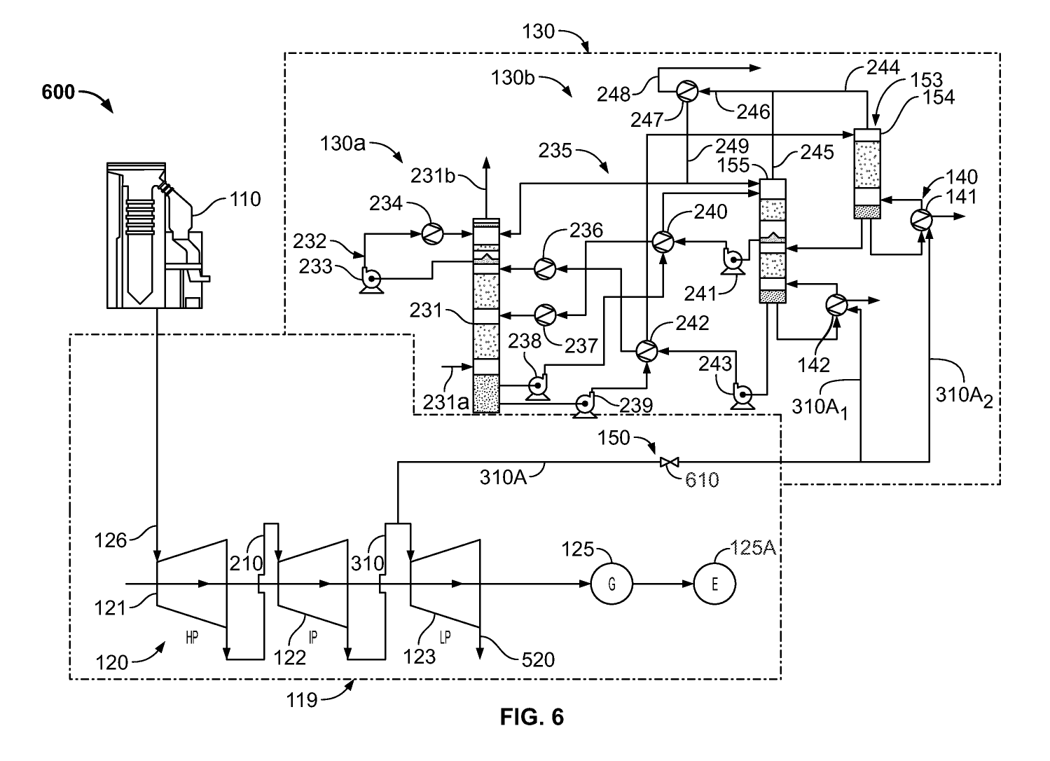

FIG. 6 illustrates a schematic, simplified process diagram of a plant 600 according to another embodiment of the disclosure. The primary components of the plant 600 are the same as shown and described above with reference to the plant 300 of FIG. 3. However, in this embodiment, a flow control device 610 replaces the auxiliary turbine 124 (FIG. 3) as the secondary source of steam 150. The flow control device 610 is provided on the auxiliary LP steam line 310A. The flow control device 610 may be a throttle valve. The flow control device 610 may be selected, controlled and/or adjusted to regulate the amount of steam provided to the auxiliary turbine 124. In another embodiment, the flow control device 610 may replace the auxiliary turbine 124 of FIG. 2 and be provided on the auxiliary IP steam line 210A. In yet another embodiment, the flow control device 610 may replace the auxiliary turbine 124 of FIG. 1 and be provided on the auxiliary HP steam line 126A.

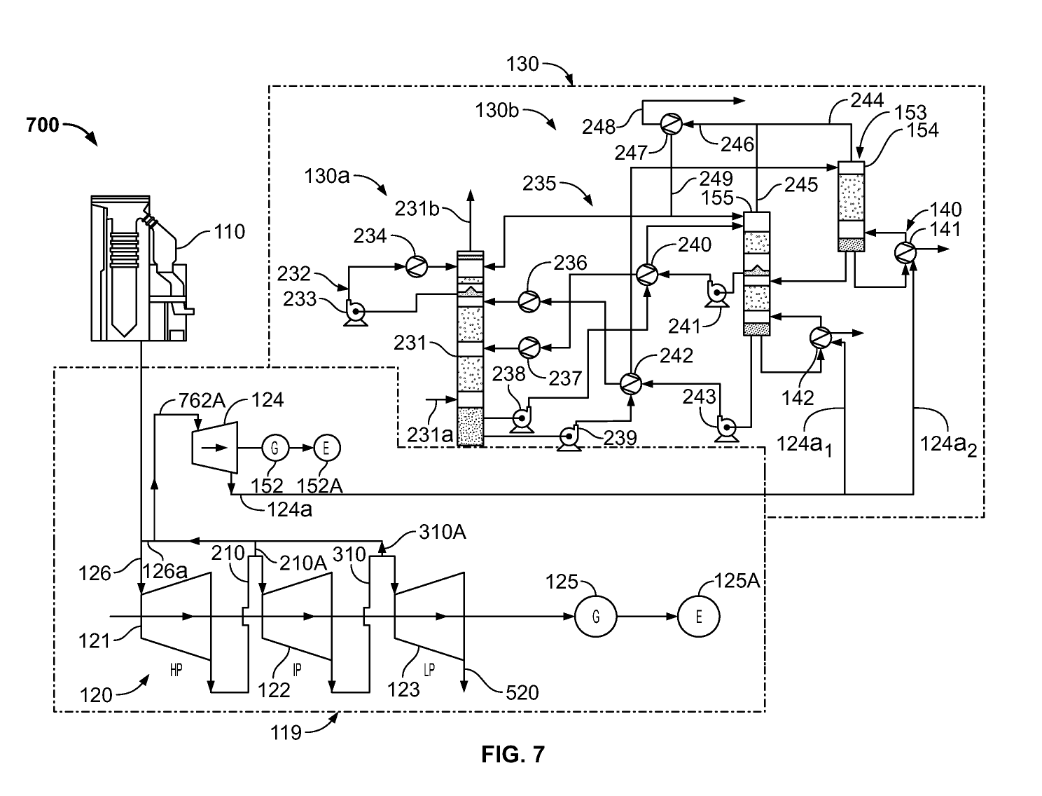

FIG. 7 illustrates a schematic, simplified process diagram of a plant 700 according to another embodiment of the disclosure. The primary components of the plant 700 are the same as shown and described above with reference to the plant 100 of FIG. 1. However, in this embodiment, the steam line to the auxiliary turbine 124 is an auxiliary combined steam line 726A in place of the auxiliary HP steam line 126A (FIG. 1). The auxiliary steam line 726A receives steam from the auxiliary HP steam line 126A, auxiliary IP steam line 210A and the auxiliary LP steam line 310A.

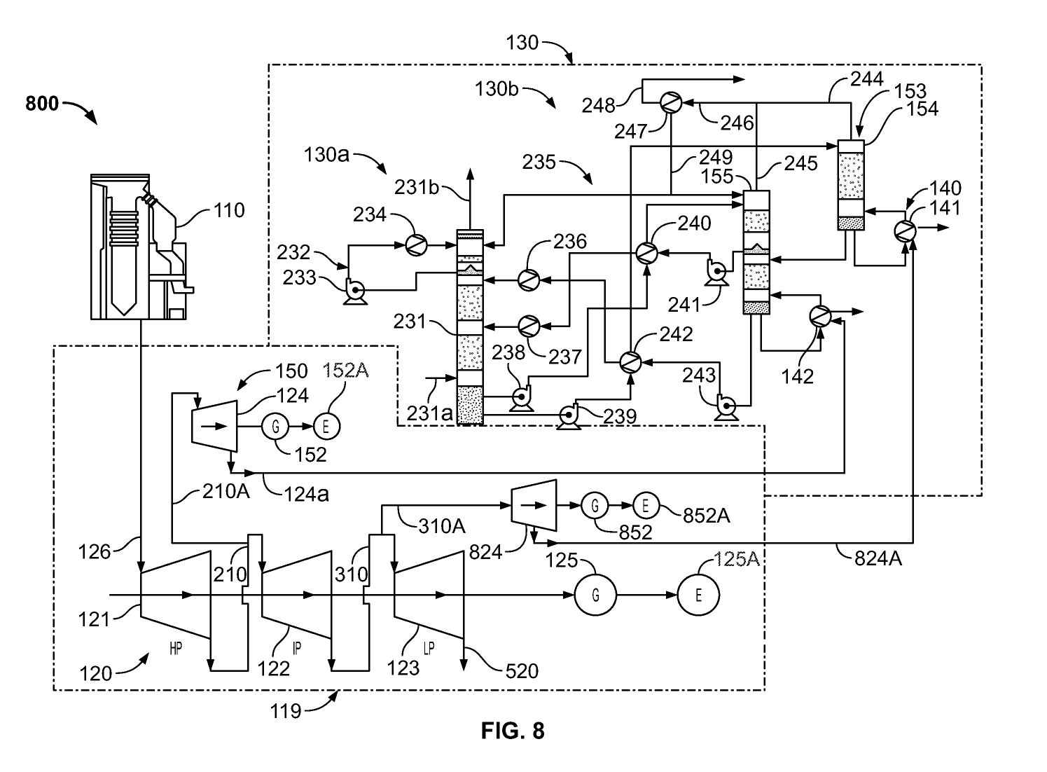

FIG. 8 illustrates a schematic, simplified process diagram of a plant 800 according to another embodiment of the disclosure. The primary components of the plant 800 are the same as shown and described above with reference to the plant 200 of FIG. 2. However, in this embodiment, the auxiliary steam line 124a provides steam only to the LP regenerator column 155, and not to the HP regenerator column 154. Instead, steam from the LP steam line 310 is provided to a second auxiliary steam turbine 824 via an auxiliary LP steam line 310A. The second auxiliary steam turbine 824 is coupled to a second auxiliary power generator 852 to generate electricity 852A. In another embodiment, one or more second auxiliary steam turbines 824 may be used. Steam is discharged from the second auxiliary steam turbine 810 via a second auxiliary steam line 824A, which provides steam to the HP regenerator column 154. In another embodiment, steam from the HP steam line 126 is provided to the auxiliary turbine 124 via an auxiliary HP steam line 126A. In yet another embodiment, steam from both the HP steam line 126 and the auxiliary LP steam line 210 is provided to the auxiliary turbine 124.

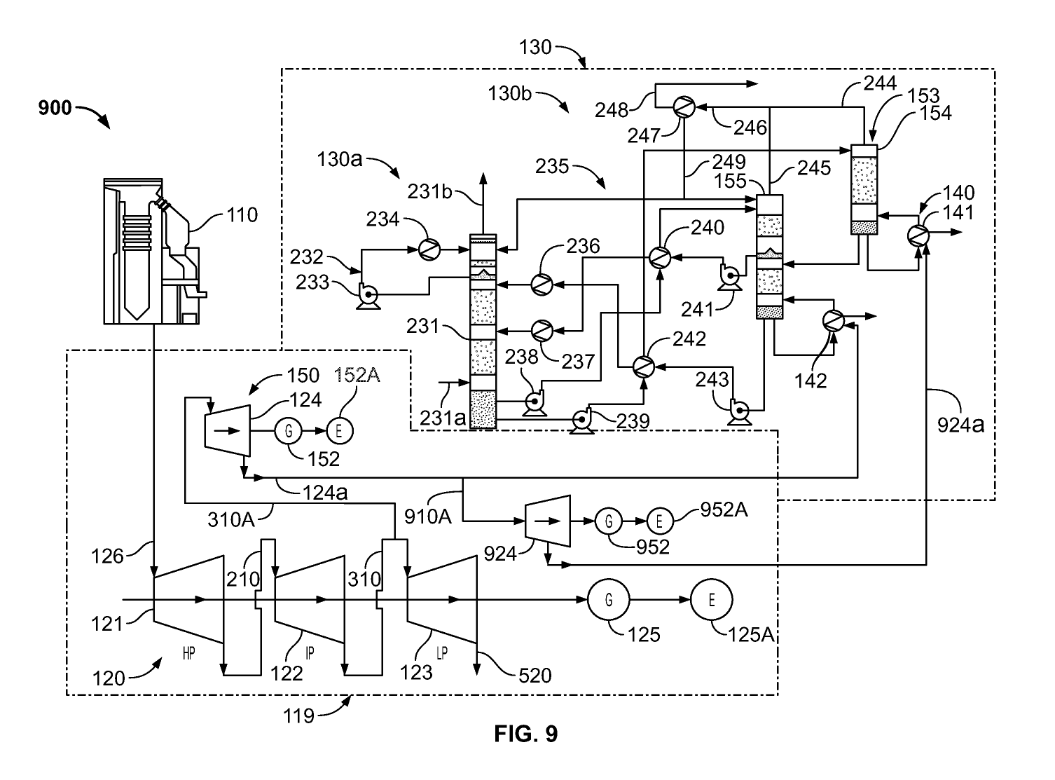

FIG. 9 illustrates a schematic, simplified process diagram of a plant 900 according to another embodiment of the disclosure. The primary components of the plant 900 are the same as shown and described above with reference to the plant 300 of FIG. 3. However, in this embodiment, the auxiliary steam line 124a provides steam only to the LP regenerator column 155, and not to the HP regenerator column 154. Instead, at least some steam from the auxiliary steam line 124a is bypassed via a auxiliary steam bypass line 910A to a second auxiliary steam turbine 924. In another embodiment, one or more second auxiliary steam turbines 924 may be used. The second auxiliary steam turbine 924 is coupled to a second auxiliary power generator 952 to generate electricity 952A. Steam is discharged from the second auxiliary steam turbine 910 via a second auxiliary steam line 924A, which provides steam to the HP regenerator column 154. In another embodiment, steam from one or any combination of the HP steam line 126, IP steam line 210, and LP steam line 310 may be provided to the auxiliary turbine 124.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A plant, comprising:
a boiler unit that produces steam;
a power generation unit comprising at least one power generation turbine that receives the steam from the boiler unit;
a gas recovery unit comprising two or more regenerator columns; and
a secondary source of steam providing steam to each of the two or more regenerators columns at different rates.

2. The plant of claim 1, wherein the gas recovery unit comprises an amine based scrubbing process.

3. The plant of claim 1, wherein the secondary source of steam comprises an auxiliary turbine.

4. The plant of claim 1, wherein the secondary source of steam comprises a flow control device.

5. The plant of claim 1, wherein the power generation unit comprises a high pressure turbine and high pressure steam is provided to the secondary source of steam from a high pressure steam feed to the high pressure turbine.

6. The plant of claim 1, wherein the power generation unit comprises a high pressure turbine and an intermediate pressure turbine, and steam is provided to the secondary source of steam from any one of the high pressure steam feed to the high pressure turbine, and the intermediate pressure steam feed to the intermediate pressure turbine.

7. The plant of claim 1, wherein the power generation unit comprises a high pressure turbine, an intermediate pressure turbine, and a low pressure turbine, and steam is provided to the secondary source of steam from any one of the high pressure steam feed to the high pressure turbine, the intermediate pressure steam feed to the intermediate pressure turbine, the low pressure steam feed to the low pressure turbine, and any combination thereof.

8. The plant of claim 1, wherein the secondary source of steam comprises an auxiliary boiler and an auxiliary turbine.

9. The plant of claim 1, wherein the secondary source of steam comprises a steam saturator, and wherein the steam saturator receives steam from any one of a high pressure feed line, an intermediate pressure feed line, a low pressure feed line, a secondary feed line from the boiler unit, and any combination thereof.

10. The plant of claim 1, wherein the secondary source of steam comprises an auxiliary turbine and a second auxiliary turbine.

11. The plant of claim 10, wherein the second auxiliary turbine receives steam from the steam discharge of the auxiliary turbine.

12. A method for providing steam to a gas recovery unit, comprising:
providing steam to a secondary source of steam from either a boiler unit or a power generation unit;
discharging steam from the secondary source of steam; and
providing steam discharged from the secondary source of steam to two or more regenerator columns of a gas recovery unit at different rates.

13. The method of claim 12, wherein steam is provided to the secondary source of steam from the boiler unit.

14. The method of claim 12, wherein steam is provided to the secondary source of steam from the power generation unit.

15. The method of claim 12, wherein the secondary source of steam comprises at least one auxiliary turbine.

16. The method of claim 12, wherein the secondary source of steam comprises a steam saturator.

17. The method of claim 12, further comprising:
providing steam to a power generation unit to generate electricity.

18. The method of claim 12, wherein the gas recovery unit separates an acid gas from a gas steam.

19. The method of claim 12, wherein the gas recovery unit is a CO₂ recovery unit.

20. The method of claim 12, wherein the gas recovery unit comprises two or more reboilers.

21. The method of claim 12, wherein a flow steam provided to the gas recovery unit is varied in response to changes in power generated by the power generation unit.
